(19) United States
(12) Patent Application Publication
(10) Pub. No.: US 2004/0066415 A1
(43) Pub. Date: Apr. 8, 2004

(54) Method of implementing a soft input panel interface

(76) Inventors: Geok Pei Khoo, Singapore (SG); Wan Yen Tan, Singapore (SG)

Correspondence Address: HEWLETT-PACKARD COMPANY, Intellectual Property Administration, P.O. Box 272400, Fort Collins, CO, 80527-2400, US

(21) Appl. No.: 10/264,966

(22) Filed: Oct. 4, 2002

(51) Int. Cl. G09G 5/00

(52) U.S. Cl. 345/792; 345/702

(57) ABSTRACT

An improved user interface for a telephone dialer application in a portable device and a method for implementing a display area for the device are provided. Existing telephone dialer application in a portable device is less user friendly as it obscures an entire display area of a portable device. The present invention allows a user to simultaneously access both the dialer and other applications. Further, the dialer user interface has an input display section for displaying an input received through a user's initiation or transmitted from a separate application.

### BACKGROUND OF THE INVENTION

1. Field of the Invention

The present invention relates to an improved user interface for a dialer application in a portable device. More particularly, it relates to a method of implementing a display area of the portable device with a soft input panel for the dialer application.

2. Description of Background Information.

In the quest for connectivity and information accessibility, portable computing devices are increasingly bundled with communication capabilities. A typical example is the Wireless Digital Assistant (WDA), essentially a Personal Digital Assistant (PDA), where computing and communication tasks are performed within a single device.

An existing user interface provided by Microsoft® Merlin platform for a telephone application in a WDA is illustrated in FIG. 1. Typically, when a user wishes to initiate a call from his WDA, he activates the Merlin telephone application to display the user interface on a display device. The user enters his input primarily by tapping a stylus or a finger on various buttons displayed in the user interface.

From FIG. 1, one notes that the prior art user interface demands almost a full display area of the WDA. Since display area is a precious asset in such portable devices and accessibility to information is also a necessity, the full display phone application clearly denies a user of access to other applications and information unless he minimizes the display of the user interface or switches between applications.

Hence, an improved user interface and a method of implementing a display area of a portable device having a soft input panel for a dialer application are needed.

### SUMMARY OF THE INVENTION

The present invention provides an improved user interface utilizing a soft input panel (SIP) in a dialer application and a method of implementing a display area of a portable device with the soft input panel.

The soft input panel interface is displayed on a first part of a display area of the portable computer. In a second part of the display area, a separate application is displayed and is simultaneously accessible to a user. The user may tap on soft button sections displayed on the first part to enter his input. The results from this action will be displayed in an input display section within the first part of the display. Alternatively, a user may block-select an appropriate input from the application displayed in the first part of the display area. The selected input is automatically transmitted to the dialer and displayed in the input display section. In another alternative, an appropriate input may be automatically located by a search algorithm. Thereafter, the input is transmitted to the dialer application and displayed in the input display section.

The input may be handled differently according to the mode of the dialer, namely, phone mode or messaging mode, viz., the Short Message Service (SMS) mode. Additionally, a soft button section may switch from a first function to a second function when a call status changes, such as when a call is connected or disconnected and when an incoming second call is received during a first call.

### BRIEF DESCRIPTION OF THE DRAWINGS

The present invention will be described with reference to the accompanying drawings, in which:

FIG. 1 shows a prior art user interface.

FIG. 2 shows a first example of the input display section according to the present invention, including an input display section.

FIG. 3 shows a first example of the present invention, where the function of a soft button section switches in the user interface.

FIG. 4 shows a first example of the present invention, where the function of another button switches in the user interface.

FIG. 5 shows a second example of the user interface according to the present invention.

FIG. 6 shows a flow sequence of a first embodiment of the present invention.

FIG. 7 shows a flow sequence of a second embodiment of the present invention.

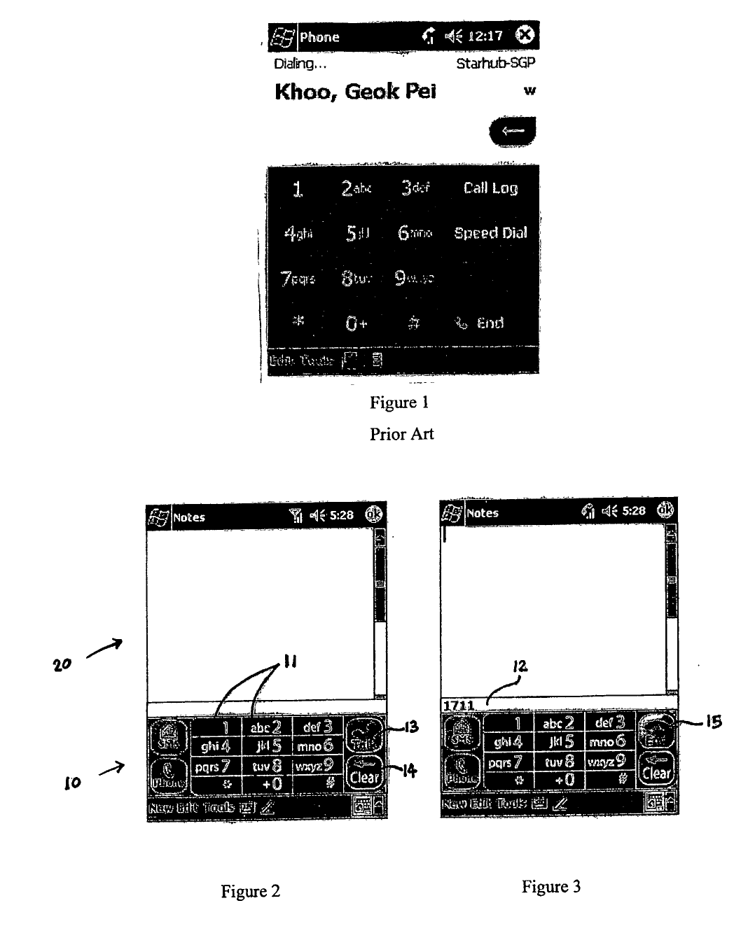

### DETAILED DESCRIPTION

The present invention is particularly suited to portable devices, where display area is generally palm-size. Such portable devices include Wireless Digital Assistants (WDAs), palmtop organizers and portable computing devices.

FIG. 2 shows a full screen or display area according to the present invention of a WDA when a user activates both the dialer 10 and a separate application 20, viz., “Notes.” The soft input panel of the dialer 10 is located on a first part of the display area. The user interface of the “Notes” application 20 is arranged on a second part of the display area to allow simultaneous access to both the dialer 10 and the “Notes” application 20, such as a contiguous arrangement shown in FIG. 2. To initiate a call, a user may tap on the soft button sections defined on the display area to select and enter a telephone number for dialing. The user input is immediately displayed in an input display section 12 within the first display area. To initiate connection after input is complete, a user taps on the “Talk” button section 13.

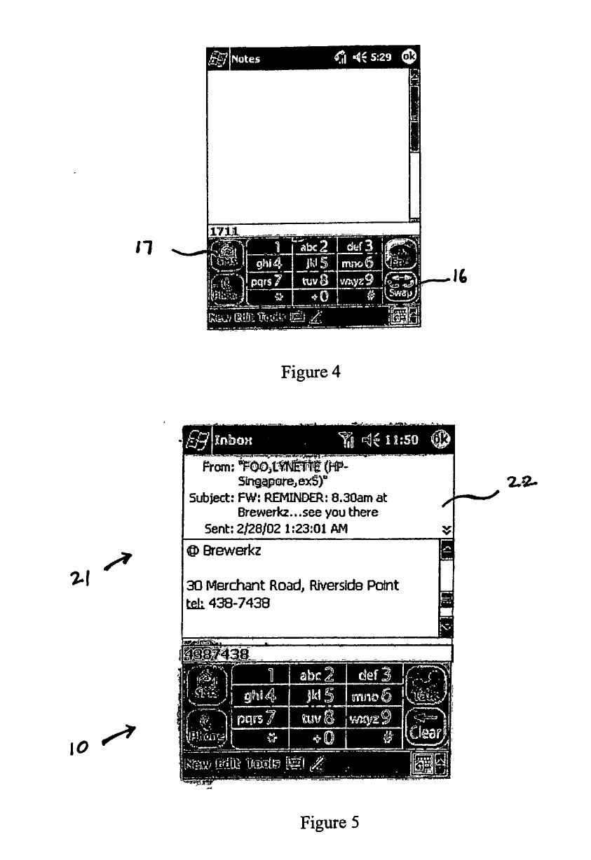

While the call is connecting or connected, the “Talk” button section 13 switches function to an “End” function (shown in FIG. 3), which also indicates that an active call is in progress. The “End” button section 15 may be tapped during an active call to disconnect it. If there is an incoming second call during the active call, the “Clear” button section 14 switches function to a “Swap” function (shown in FIG. 4). The “Swap” button section 16 may be tapped to put the current active call on hold to allow the user to switch to the second call. The user may tap on the “Swap” button section 16 again to revert to the first call. When the user switches back to the first call, the “Swap” button section 16 still displays as “Swap” to allow the user to switch between the two calls if the second call is still connected. To disconnect one of the calls, the user simply taps on the “End” button section 15. The call then disconnects and the “Swap” button section 16 switches to a “Clear” function. The “Clear” button section 14 can be tapped to clear an input displayed in the input display section 12 (FIG. 3). The user can now resume with the remaining call until the user taps on the “End” button section 15 to disconnect the call. When this call is disconnected, the “End” button section 15 then switches to a “Talk” function.

FIG. 5 illustrates a screen, where both the dialer 10 and an electronic mail application 21 are active. In the screen illustrated in FIG. 5, an electronic mail message 22 contains a telephone number, which the user is able to access simultaneously with the dialer 10. According to a first aspect of the present invention, the user may view the number in the electronic mail application 21 displayed on the second part of the display area and tap on the soft button sections 11 accordingly to input the numerals into the dialer application.

According to a second aspect of the invention, the user may enter his input into the dialer by block-selecting the numbers or text from the electronic mail application 21 in the second display area. If the dialer application 10 is active, text selection made by a user in the second display area is automatically transmitted to the dialer 10. The dialer 10 receives and displays the input in the input display section 12.

According to a third aspect of the invention, a search algorithm may be used to auto-locate a relevant number for input to the dialer 10. One way to locate and identify a relevant number is by searching for a string of numbers, or searching for an identifier, such as “phone” and “tel.” preceding a string of numbers. When such information is located, the string of numbers is transmitted to the dialer 10 and displayed in the input display section 12 of the dialer interface.

In some cases, telephone numbers are expressed by a character sequence or by a combination of numerals and characters, for example, “1800-HOTLINE” which translates into its numeric form “1800-4685463.” Each character is pre-associated with a numeral as illustrated in FIGS. 2-5. For example, an “H” character is associated with and thus translates to a digit “4”. During translation, the numeral pre-associated with each character is determined and replaces the character as the input. When such an input is received by the dialer 10 and if the dialer 10 is in a phone mode, the dialer 10 then displays the input display section 12. The displayed input may be translated or untranslated; it may be translated when a call is initiated or when a user initiates a translation.

Optionally, when the “SMS” button section 17 has been tapped, the received input from the separate application (20 or 21) is used to compose a Short Message Service (SMS) message whether the input comprises numerals or characters or a combination of both.

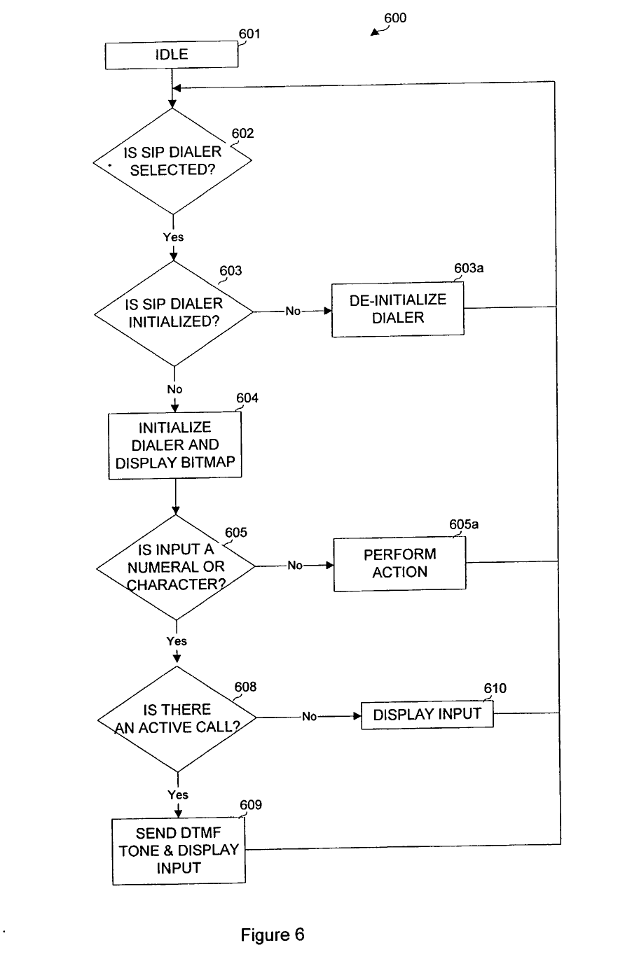

FIG. 6 illustrates a first flow sequence 600 describing a first aspect of the invention. A portable device is in an IDLE state 601 awaiting the user's instructions. When a user activates the dialer application 10, an IS SIP DIALER SELECTED? decision step 602 proceeds to an IS SIP DIALER INTIALIZED? decision step 603. The SIP dialer is initialized if resources have been created for radio communication. If the dialer 10 has been initialized, it will be de-initialized in a DEINITIALIZE DIALER step 603a. If the dialer 10 is not yet initialized, the sequence 600 proceeds to an INTIALIZE DIALER AND DISPLAY BITMAP step 604. In this INITIALIZE DIALER AND DISPLAY BITMAP step 604, if the dialer 10 has not been initialized, it is initialized and the dialer bitmap, which includes the soft button sections 11 and the input display section 12, is displayed on a first part of a display area of the portable device. If the dialer 10 has been initialized, the sequence 600 proceeds to a DEINITIALIZE DIALER step 603a.

After the INITIALIZE DIALER AND DISPLAY BITMAP step 604, the sequence 600 proceeds to wait for the user's input in an IS INPUT A NUMERAL OR CHARACTER? decision step 605. The user can tap on the soft button sections or select text from a separate application 20 displayed on a second part of the display area described earlier. If the user selects text from the application 20, the selected text is automatically transferred to the dialer 10. The dialer receives the selected input and displays it in the first input display section 12. If the user's input relates to a function or an action, such as “Talk” 13 and “Clear” 14, the sequence 600 proceeds to a PERFORM ACTION step 605a to execute the user-instructed action. If the input contains a numeral or a character or both, the sequence 600 proceeds to an IS THERE AN ACTIVE CALL? decision step 608, to determine whether there is any current active call. If a call is active, the sequence 600 proceeds to a SEND DTMF TONE & DISPLAY INPUT step 609. Dual Tone Multi-Frequency (DTMF) tones are sent to a callee, i.e., the recipient of the call. If the callee is an automated answering service, the DTMF tones may be recognized as a user-input. If the callee is a person, the DTMF tones are merely played. If there is no active call, the sequence proceeds to a DISPLAY INPUT step 610. Both the SEND DTMF TONE & DISPLAY INPUT step 609 and the DISPLAY INPUT step 610 proceed to the IS SIP DIALER SELECTED? decision step 602 to await further instructions or de-initialization.

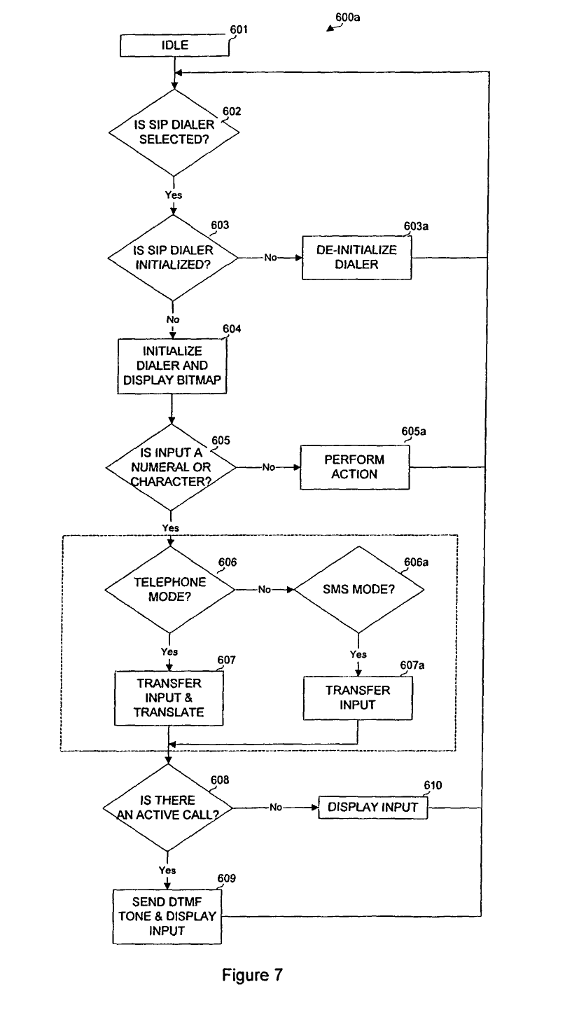

FIG. 7 shows a second flow sequence 600a according to a second embodiment of the present invention. The second sequence 600a is substantially similar to the first sequence 600, except on the handling of input according to a numeral and/or character input. At IS INPUT A NUMERAL OR CHARACTER? decision step 605, it is determined whether the input is a numeral or a character or a combination of both. If the input does not contain a numeral or a character, it is identified as an action and the sequence 600a proceeds to a PERFORM ACTION step 605a. If the input contains a numeral or a character, the sequence 600a proceeds to a TELEPHONE MODE? decision step 606. If the dialer 10 is in a phone mode for making voice calls, the sequence 600a proceeds to a TRANSFER INPUT & TRANSLATE step 607, where the input is automatically transmitted to the dialer 10 and displayed in the input display section 12 of the dialer interface. If the dialer 10 is not in a phone mode, the sequence 600a proceeds to an SMS MODE? decision step 606a. The input is automatically transmitted to the dialer 10 for composing an SMS message in a TRANSFER INPUT step 607a. The dialer application receives the message, which is displayed in the input display section 12 and can be further edited by the user. In the SMS mode, the soft button sections may accordingly be configured to allow character input. Alternatively, a soft keyboard panel may be activated at a user's instruction for editing the message.

What is claimed is:

1. A method of implementing a display area of a portable device having a soft input panel interface for a dialer, comprising:
displaying the soft input panel on a first part of the display area, the panel having a plurality of soft button sections and an input display section for displaying an input; and
displaying a separate application on a second part of the display area for allowing simultaneous display of and access to the dialer and the separate application.

2. The method according to claim 1 further includes transmitting the input from the separate application to the dialer and displaying the input in the input display section.

3. The method according to claim 1 further includes switching from a first function to a second function in a soft button section when a call status changes.

4. The method according to claim 3 wherein the call change includes one of connecting or disconnecting a call, and receiving an incoming second call during a first call.

5. The method according to claim 1 further includes translating a character input into a numeric form according to a dialer mode.

6. The method according to claim 1 further includes retaining a character input in its character form according to the dialer mode.

7. The method according to claim 1 further includes selecting the input by a user from the separate application.

8. The method according to claim 1 further includes auto-locating the input in the separate application by a search algorithm.

9. A portable device having a display area and a soft input panel interface for a dialer, the display area comprising:
a first part for displaying the soft input panel, including a plurality of soft button sections and an input display section for displaying an input; and
a second part for displaying a separate application and for allowing simultaneous display of and access to the dialer and the separate application.

10. The device according to claim 9 wherein the input is transmitted from the separate application to the dialer and displayed in the input display section.

11. The device according to claim 9 wherein a soft button section switches from a first function to a second function when a call status changes.

12. The device according to claim 11 wherein the call status change includes one of connecting or disconnecting a call, and receiving an incoming second call during a first call.

13. The device according to claim 9 wherein the input is a character input which is translated into a numeric form according to a dialer mode.

14. The device according to claim 9 wherein the input is a character input which retains its character form according to the dialer mode.

15. The device according to claim 9 wherein the input is selected from the separate application by a user.

16. The device according to claim 9 wherein the input is auto-located in the separate application by a search algorithm.
